(19) United States
(12) Patent Application Publication
(10) Pub. No.: US 2007/0020385 A1
(43) Pub. Date: Jan. 25, 2007

(54) Production method of electrode for electrochemical device and production method of electrochemical device

(75) Inventors: Katsuo Naoi, Tokyo (JP); Tadashi Suzuki, Tokyo (JP); Yukio Kawashima, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TDK CORPORATION, Tok yo (JP)

(21) Appl. No.: 11/488,044

(22) Filed: Jul. 18, 2006

(30) Foreign Application Priority Data
Jul. 25, 2005 (JP) 2005-214204

(51) Int. Cl. B05D 5/12; B05D 3/12; B05D 3/02

(52) U.S. Cl. 427/58; 427/379; 427/359

(57) ABSTRACT

In the inventive fabrication process for electrodes for electrochemical devices, when the coating film is rolled so as to increase its density, the given binder solvent is intentionally allowed to remain in an amount good enough to keep pores on the surface of the active substance uncrushed, and after the rolling operation is carried out, the solvent extraction operation is conducted to remove the binder solvent remaining in the pores in the coating film. Thus, an electrochemical device using an electrode according to the inventive fabrication process is much improved in electrostatic capacity as well as in durability and reliability as well.

### BACKGROUND OF THE INVENTION

1. Field of the Invention

The present invention relates to a fabrication process for electrodes used with electric double-layer capacitors (EDLCs), lithium ion secondary batteries, etc., and an electrochemical device fabrication process that involves part of that process.

2. Description of the Prior Art

Electrochemical devices such as electric double-layer capacitors (EDLCs) and lithium ion secondary batteries are now widely used for cell phones, PDAs (personal digital assistants), etc.

Electrodes for such electrochemical devices are fabricated by coating a collector (support carrier) such as an aluminum or copper foil with an electrode-formation coating material comprising an active substance, a binder, a binder soluble solvent or a solvent for imparting plasticity to an electrode, which is applied when an insoluble binder is used (these solvents are collectively called the “binder solvent”), and an optionally used conductive aid such as carbon black.

When polyvinylidene fluoride (PVDF) is used as the binder for the preparation of the electrode-formation coating material, N-methyl-2-pyrrolidinone (NMP) is usually used as the binder solvent.

In an electrode fabrication process by such coating film formation, the binder solvent remains in the electrode film in no small amounts. Especially with the fabrication of an electrochemical device with which activated charcoal having a large surface area is used as its active substance, there is a problem that the electrostatic capacity of the activated charcoal dwindles due to the adsorption of the binder solvent onto its surface. Also, the remaining binder solvent is responsible for drops of the durability and reliability of the electrochemical device.

To solve such problems, there have been various techniques proposed so far in the art, for instance, a vacuum drying process wherein coating films are dried at high temperatures for an extended period of time (JP-A8-55761), and a process wherein coating films are first washed with a low-boiling solvent, and the dried (JP-A2000-216065).

However, the binder solvent used for the fabrication of an electrode for electrochemical devices such as electric double-layer capacitors (EDLCs) and lithium ion secondary batteries still remains in the electrode in no small amounts only by virtue of ordinary drying techniques. Further, in activated charcoal or other porous carbon material used as the active substance, there are surface pores. The pores are broken down into macro-pores (of 50 nm or greater in diameter), micro-pores (of 2 to 50 nm in diameter), and micro-pores (2 nm or less in diameter).

The binder solvent used on electrode fabrication is difficult to remove, because of adsorption to such pores. In particular, it is very difficult to remove the solvent adsorbed to the micropores.

A certain solvent polymerizes upon heating. As that solvent is heated while adsorbed onto a pore, it causes the solvent to polymerize within that pore; solvent removal by heating may possibly clog up the pore with the polymer.

Thus, as the solvent is adsorbed to the surface pores of activated charcoal or the pores are clogged up with the polymer resulting from the solvent, electrolyte ions fail to have access to the surface of activated charcoal, offering a problem that the electrostatic capacity of activated charcoal dwindles.

With such considerations in mind, it is still desired to make further improvements in the above prior art techniques, thereby achieving a process for the fabrication of an electrode for electrochemical devices, which ensures that the electrostatic capacity of a carbonaceous material as an active substance is increased with much improvement in the reliability of an electrochemical device.

### SUMMARY OF THE INVENTION

Such being the situation, the inventors have made study after study on the revamping of just only operating conditions in a part of the fabrication process but also the order of a series of steps in the whole fabrication process and operating conditions, etc. for each process step, finding that if an operation for increasing the rate of removal of binder solvent residues is carried out after a coating film is rolled to increase its density rather than increasing the rate of removal of binder solvent residues before rolling the coating film to increase its density, cell capacity grows larger, and better enough performance stability during later use is achievable as well. Such findings have underlain the present invention.

Thus, the present invention provides a process for fabricating an electrode for electrochemical devices, said electrode comprising an active substance and a binder on a support carrier, which comprises:

a coating material providing step of providing an electrode-formation coating material comprising said active substance, said binder and a binder solvent,

a coating step of coating said coating material on said support carrier to form a coating film for said electrode,

a first coating film drying step for regulating an amount of the binder solvent contained in a coating film formed in said coating step to within a range of 10 to 35 wt %,

a rolling step of rolling the coating film in which the amount of the binder solvent is regulated by said first coating film drying step,

a solvent extraction step for removing the binder solvent remaining in the coating film after said rolling step, and

a second drying step of drying the coating film after said solvent extraction step.

In a preferable embodiment of the present invention, the extracting solvent used in said solvent extraction step is compatible with said binder solvent, and has a boiling point lower than that of said binder solvent.

In a preferable embodiment of the present invention, the amount of the binder solvent remaining in an electrode after said second drying step is 1 wt % or less.

In a preferable embodiment of the present invention, the coating film after said rolling step has a density of 0.55 to 0.75 g/cm³.

In a preferable embodiment of the present invention, the second drying step is carried out in a vacuum.

In a preferable embodiment of the present invention, said electrode for electrochemical devices is an electrode for electric double-layer capacitors, an electrode for lithium ion secondary batteries, or an electrode for hybrid capacitors.

The present invention also provides an electro-chemical device fabrication process, wherein:

an electrode for electrochemical devices is fabricated by the above process for fabricating an electrode for electrochemical devices, and thereafter,

at least the thus fabricated electrode, a separator, an electrolyte and a housing are assembled together into an electrochemical device.

In the inventive fabrication process for electrodes for electrochemical devices, when the coating film is rolled so as to increase its density, the given binder solvent is intentionally allowed to remain in an amount good enough to keep micropores on the surface of the active substance uncrushed, and after said rolling operation is carried out, the solvent extraction operation is conducted to remove the binder solvent remaining in the pores in the coating film. Thus, an electrochemical device using an electrode according to the inventive fabrication process is much improved in electrostatic capacity as well as in durability and reliability as well.

### BRIEF EXPLANATION OF THE DRAWINGS

FIG. 1 is schematically illustrative in section of one preferred embodiment of an electric double-layer capacitor (EDLC),

FIG. 2 is schematic front representation of one preferred embodiment of a lithium ion secondary battery, and

FIG. 3 is a sectional view taken on an arrow A-A of FIG. 2.

### DETAILED EXPLANATION OF THE INVENTION

The best mode for carrying out the present invention is now explained at great length with reference to the accompanying drawings.

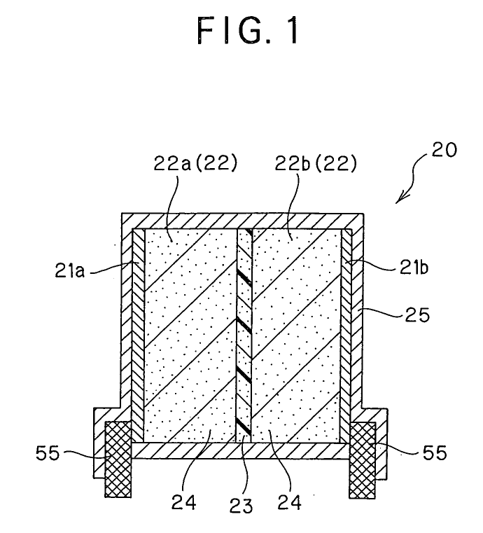

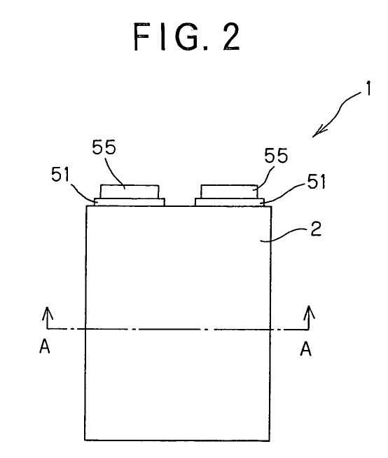

Prior to giving an explanation of the process for the fabrication of an electrode for electrochemical devices, and the process for the fabrication of an electrochemical device according to the present invention, the schematic structures of an electric double-layer capacitor (EDLC) and a lithium ion secondary battery—the preferable examples to be fabricated—are first explained with reference to FIGS. 1 and 2.

### Explanation of the Schematic Structure of an Electric Double-Layer Capacitor (EDLC)

FIG. 1 is schematically illustrative in section of the electric double-layer capacitor that is to be fabricated by the present invention.

As depicted in FIG. 1, an electric double-layer capacitor 20 (electrochemical device) includes an electrode pair 22 comprising a positive electrode 22a (the first electrode) and a negative electrode 22b (the second electrode) which are oppositely located.

The positive electrode 22a (the first electrode) and the negative electrode 22b (the second electrode), which form part of the electrode pair 22, are held in such a way as to be joined to a positive electrode collector 21a and a negative electrode collector 21b, respectively, each as a support carrier.

Such an electrode pair 22 is housed within a housing 25, and a separator 23 is located between both the electrodes 22a and 22b. And then, both the electrodes 22a and 22b and the separator 23 are impregnated therein with an electrolyte 24. Reference numeral 55 is indicative of projecting tabs that are connected to the ends of the positive electrode collector 21a and the negative electrode collector 21b, and act as external connector terminals. Note here that although the separator 23 is shown as being located in the electrolyte 24, the separator 23 impregnated in an electrolysis solution may be held between the electrodes 22a and 22b. Each component is now explained in further details.

Collector

For the collectors 21 and 21, there is no critical requirement but to be made up of a member having electrical conductivity. For instance, sheets of metals such as carbon steel, stainless steel, aluminum alloy or aluminum or a metal-plated polymer sheet may be used as the occasion may be.

Electrodes

The electrodes 22a and 22b are each formed by coating of a coating material comprising an active substance and a binder with a conductive aid added thereto if required. For the reason of coating formation, the binder solvent remains in the electrodes slightly, if not in large amounts. Although it is ideal that the binder solvent does not remain in the electrodes at all, it is here acceptable that the binder solvent remains in an amount of 1 wt % or less, preferably 0.5 wt % or less, and more preferably 0.001 to 0.1 wt %.

For the active substance, for instance, use may be made of carbon materials (e.g., activated charcoal) obtained by activation of raw coals (e.g., petroleum cokes, etc. produced from delayed cokers using as starting oils bottom oils stemming from fluid cat-crackers for petroleum-base heavy oils or oil residues stemming from reduced pressure evaporators).

For the conductive aid, carbon black, graphite or the like may be used.

For the binder, for instance, use may be made of polyvinylidene fluoride (PVDF), polytetrafluoroethylene (PTFE), polyethylene (PE), polypropylene (PP), and fluoro-rubber.

Separator

The separator 23, for instance, may be made up of a porous film formed of a material containing at least one of polyolefins (e.g., polyethylene and polypropylene) (two or more polyolefins include a laminate of two or more films), polyesters such as polyethylene terephthalate, thermoplastic fluororesins such as ethylene-tetrafluoroethylene copolymers and celluloses; polyamide-imides (PAI); and polyacrylnitriles (PAN)).

When the separator 23 is applied in a sheet form, it is preferably a sheet formed of a micro-porous film, a woven fabric sheet or a non-woven sheet having an air permeability of about 5 to 2,000 sec./100 cc, as measured according to JIS-P8117, and a thickness of about 5 to 100 μm.

The separator 23 may have a shutdown function as well. This could hold back thermal runaway that might otherwise occur due to the clogging of pores in the separator 23 at a time when, for some unknown reasons, there are overcharges, internal short circuits or external short circuits in the electric double-layer capacitor 20, or there is a rapid rise in the battery temperature.

Housing

The housing 25 may be formed of a can-like member formed of, for instance, carbon steel, stainless steel, aluminum alloy or metallic aluminum or, alternatively, it may be formed of a bag member comprising a metal foil/polymer film laminate (laminated film). The use of such a bag member helps achieve a low-profile, lightweight electric double-layer capacitor 20, and improve barrier capability with respect to outside air or moisture, ensuring sufficient prevention of degradation.

For the laminated film provided for the purpose of, e.g., making sure of insulation between the metal foil and a terminal leading to a power source, it is preferable to use a laminate obtained by laminating on both surfaces of an aluminum or other metal foil polyolefinic heat bondable polymer layers such as polypropylene or polyethylene layers, polyester-base heat resistant polymer layers, etc.

Electrolyte

For the electrolyte 24, for instance, an electrolysus solution in which an electrolyte such as triethylmethylammonium borofluoride (TEMA.BF₄) or tetraethylammonium borofluoride (TEA.BF₄) is dissolved in a solvent or a polymer electrolyte may be used. It is also acceptable to use a solid state electrolyte.

The solvent for the electrolysis solution used here is preferably a non-aqueous solvent, or an aprotic polar organic solvent that does not break up even at a high operating voltage. Such solvents are exemplified by carbonates such as ethylene carbonate (EC), propylene carbonate (PC), butylene carbonate, dimethyl carbonate (DMC), diethyl carbonate (DEC) and ethyl methyl carbonate; cyclic ethers such as tetrahydrofuran (THF) and 2-methyltetrahydrofuran; cyclic ethers such as 1,3-dioxolane and 4-methyldioxolane; lactones such as γ-butyrolactone; sulforanes such as 3-methylsulforane; dimethoxyethane, diethoxyethane, ethoxymethoxyethane, and ethyldiglime.

Among others, preference is given to ethylene carbonate (EC), propylene carbonate (PC) and butylene carbonate, although propylene carbonate is particularly preferred.

If required, additives may be added to the electrolysis solution. The additives, for instance, include vinylene carbonate, and sulfur-containing organic compounds.

The polymer electrolyte is exemplified by gelled polymer electrolytes, and intrinsic polymer electrolytes. The gelled polymer electrolyte here refers to an electrolyte in which a polymer is swollen by a non-aqueous electrolysis solution thereby holding the non-aqueous electrolyte in the polymer, and the intrinsic polymer electrolyte here refers to an electrolyte in which a lithium salt is dissolved in a polymer.

For such polymers, for instance, use may be made of polyacrylnitrile, polyethylene glycol, polyvinylidene fluoride (PVdF), polyvinyl pyrrolidone, copolymers of acrylates including tetraethylene glycol diacrylate, polyethylenoxide diacrylate, and ethylene oxide and acrylates having polyfunctional groups, and copolymers of polyethylene oxide, polypropylene oxide, and vinylidene fluoride and hexafluoropropylene.

### Explanation of the Schematic Structure of a Lithium Secondary Battery

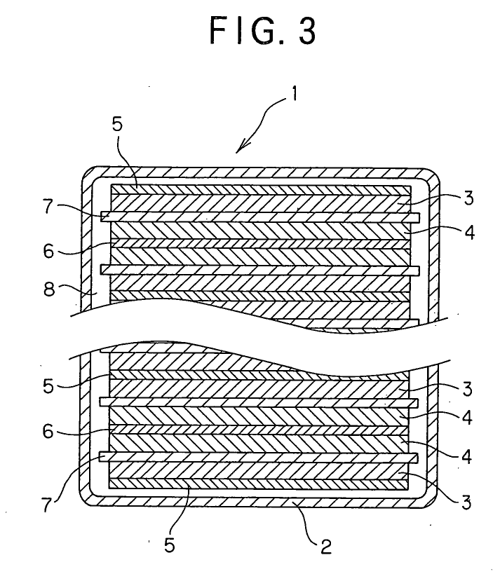

FIG. 2 is schematically illustrative in section of one preferred embodiment of the lithium secondary battery that is to be fabricated by the present invention, and FIG. 3 is a sectional view taken on an arrow A-A of FIG. 2.

As depicted generally in FIG. 2, a lithium ion secondary battery 1 comprises a battery internal structure wrapped up with a housing 2, collector tabs 55 that jut out the housing 2, providing base points for external connector terminals, and insulators 51 located below the bases of the collector tabs 55.

The battery internal structure is now explained in details.

As depicted in FIG. 3, the lithium ion secondary battery 1 comprises a positive electrode 3, a negative electrode 4, and a separator 7 in a laminated or wound form. These components are housed together with an electrolyte 8 in a housing 2. Note here that the lithium ion secondary battery 1 may be of various battery forms such as a laminated or cylindrical battery form.

Positive Electrode & Negative Electrode

Both the positive 3 and the negative electrode 4 have a function of occluding and releasing lithium ions, and each comprises an electrode active substance (positive or negative electrode active substance) and a binder with a conductive aid added thereto if required.

The positive electrode active substance here is an active substance used for the positive electrode of a lithium ion secondary battery, and typical thereof is LiCoO₂. To the applicant's knowledge, a composite oxide containing Li, Mn, Ni, Co and O atoms is more preferable. When the so-called quaternary metal oxide containing four such main metal elements (or a lithium tertiary oxide: LiₐMn_{b}Ni_{c}Co_{d}Oₑ) is used, it has preferably a substantially rock salt crystal structure.

The negative electrode active substance (in a sense of taking part in occlusion of lithium ions), for instance, includes manmade graphite, naturally occurring graphite, MCMB (meso-carbon microbeads), and a carbonaceous material obtained by firing of resins. Therefore, when the electrochemical device is a lithium ion secondary battery, the inventive fabrication process for electrodes for electrochemical devices is to be applied to the negative electrode.

The amount of the electrode active substance to be loaded may be optionally determined in such a way as to be enough to allow the lithium ion secondary battery 1 to have practically sufficient energy densities and enough to be not inconveniently detrimental to battery performance, and the porosity of each of the positive electrode 3 and the negative electrode 4 may be optionally determined in such a way as to have a value at which a sufficient low-profile arrangement is achievable or lower, and a value at which the diffusion of lithium ions in each electrode 3, 4 is not unduly limited or greater. In other words, it is desired for the porosity of each electrode to be determined in consideration of a sensible tradeoff between the battery thickness demanded for thickness reduction and keeping battery performance high.

Although there is no particular requirement for the binder, it is desired to use thermoplastic polymers like fluorine-base polymers, polyolefins, styrene-base polymers and acrylic polymers or elastomers like fluororubbers. More specifically, polytetrafluoroethylene, polyvinylidene fluoride (PVDF), polyethylene, polyacrylonitrile, nitrile rubber, polybutadiene, butyrene rubber, polystyrene, styrene-butadiene rubber (SBR), polysulfide rubber, hydroxypropyl methyl cellulose, cyanoethyl cellulose, and carboxymethyl cellulose (CMC) are mentioned. These binders may be used alone or in admixture of two or more.

While there is also no particular requirement for the conductive aid, it is preferable to use carbonaceous materials such as graphite, carbon black (acetylene black, etc.) and carbon fibers, and metals such as nickel, aluminum, copper and silver, among which the carbonaceous materials such as graphite, carbon black (acetylene black, etc.) and carbon fibers are more preferable in view of chemical stability. Most preferable is acetylene black because of very limited impurities.

Identical or different binders and conductive aids may be used for the positive electrode 3 and the negative electrode 4. Referring here to the electrode composition, the positive electrode 3 has preferably a positive electrode active substance:conductive agent:binder ratio in the range of 70-94:2-15:2-25 by mass or weight, and the negative electrode 4 has preferably an active substance:conductive agent:binder ratio in the range of 70-97:0-25:3-10 by mass or weight.

Further, the positive electrode 3 is integral with the positive electrode collector 5 acting as its support carrier while the negative electrode 4 is integral with the negative electrode collector 6 acting as its support carrier.

Collector

The material and configuration of the positive electrode collector 5, and the negative electrode collector 6 may be optionally selected depending on the polarities of the electrodes, in what form they are used, and how they are housed in the housing (casing); however, the positive electrode collector 5 is preferably formed of aluminum, and the negative electrode collector 6 is preferably formed of copper, stainless or nickel.

The support carriers, i.e., the positive electrode collector 5 and the negative electrode collector 6 are each preferably in a foil, mesh or other configuration. The foil or mesh configuration ensures that contact resistance can be kept low enough. In particular, it is more preferable to rely on the mesh configuration, because it ensures large surface areas and much lower contact resistance.

Separator The separator 7, for instance, may be made up of a porous film formed of a material containing at least one of polyolefins (e.g., polyethylene and polypropylene) (two or more polyolefins include a laminate of two or more films), polyesters such as polyethylene terephthalate, thermoplastic fluorine-base polymers such as ethylene-tetrafluoroethylene copolymers, and celluloses. When the separator 7 is applied in a sheet form, it is preferably a sheet formed of a micro-porous film, a woven fabric sheet or a non-woven sheet having an air permeability of about 5 to 2,000 sec./100 cc, as measured according to JIS-P8117, and a thickness of about 5 to 100 μm.

The separator 7 may have a shutdown function as well. This could hold back thermal runaway that might otherwise occur due to the clogging of pores in the separator 23 at a time when, for some unknown reasons, there are overcharges, internal short circuits or external short circuits in the electric double-layer capacitor 20, or there is a rapid rise in the battery temperature.

Housing

The housing 2 may be formed of a can-like member formed of, for instance, carbon steel, stainless steel, aluminum alloy or aluminum or, alternatively, it may be formed of a bag member comprising a metal foil/polymer film laminate (laminated film). The use of such a bag member helps achieve a low-profile, lightweight lithium ion secondary battery 1, and improve barrier capability with respect to outside air or moisture, ensuring sufficient prevention of degradation.

For the laminated film provided for the purpose of, e.g., making sure of insulation between the metal foil and a terminal leading to a power source, it is preferable to use a laminate obtained by laminating on both surfaces of an aluminum or other metal foil polyolefinic heat bondable polymer layers such as polypropylene or polyethylene layers, polyester-base heat resistant polymer layers, etc.

With the use of such a laminated film, the polyester polymer layer having a high melting point remains unmolten during heat bonding, so that there a certain space secured between the leading terminal and the metal foil of the housing bag, making sure of sufficient insulation. More specifically in this case, the thickness of the polyester polymer layer in the laminated film is preferably about 5 to 100 μm.

Electrolyte

The electrolyte 8 here is a lithium ion conductive substance and, to this end, an electrolysis solution in which a lithium salt is dissolved as an electrolyte salt or a polymer electrolyte is used. And of course, use may be made of a solid state electrolyte.

The solvent for the electrolysis solution used here is preferably a non-aqueous solvent that is poor in chemical reactivity to lithium and well compatible with a polymer solid electrolyte, an electrolyte salt or the like, and imparts ion conductivity to it, or an aprotic polar organic solvent that does not break up even at a high operating voltage. Such solvents are exemplified by carbonates such as ethylene carbonate (EC), propylene carbonate (PC), butylene carbonate, dimethyl carbonate (DMC), diethyl carbonate (DEC) and ethyl methyl carbonate; cyclic ethers such as tetrahydrofuran (THF) and 2-methyltetrahydrofuran; cyclic ethers such as 1,3-dioxolane and 4-methyldioxolane; lactones such as γ-butyrolactone; sulfolanes such as 3-methylsulfolane; dimethoxyethane, diethoxyethane, ethoxymethoxyethane, and ethyldiglime.

Among others, preference is given to ethylene carbonate (EC), propylene carbonate (PC) and butylene carbonate, although the cyclic carbonate such as ethylene carbonate (EC) is particularly preferred. Such cyclic carbonates have the properties of being higher in permittivity and viscosity than chain carbonates, so that the dissociation of the lithium salt that is the electrolyte salt contained in the electrolysis solution can be accelerated. In this respect, the cyclic carbonate is better fit for the electrolysis solution solvent for the lithium ion secondary battery 1.

However, as the cyclic carbonate accounts for too much of the solvent and the viscosity of the electrolysis grows too high, it often causes the migration of lithium ions in the electrolysis solution to be excessively held back, resulting in a sharp increase in the internal resistance of the battery. Preferably for the purpose of effective prevention of this, a chain carbonate lower in viscosity and permittivity than the cyclic carbonate is mixed with the solvent. As that chain carbonate accounts for too much of the electrolysis solution, conversely, it causes the permittivity of the solvent to become badly low, rendering the dissociation of the lithium salt in the electrolysis solution much less likely to proceed. In view of balances between these considerations, it is desired to determine the rate of the cyclic carbonate compound to the chain carbonate in the electrolysis solution.

The lithium salt (carrier salt) that provides a lithium ion supply source is exemplified by salts, for instance, LiClO₄, LiPF₆, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂) (C₄F₉S0₂), and LiN(CF₃CF₂CO)₂. These salts may be used alone or in admixture of two or more. Among others, it is very preferable to use lithium phosphate hexafluoride (LiPF₆), because much higher ion conductivity is achievable.

Further, if required, additives may be added to the electrolysis solution. The additives, for instance, include vinylene carbonate, and sulfur-containing organic compounds. The addition of these to the electrolysis solution is very preferable, because of having effects on further improvements in the storability and cycle characteristics of the battery.

As the electrolyte is in a polymer electrolyte form rather than in an electrolysis solution state (form), it allows the lithium ion secondary battery 1 to function as a polymer secondary battery. The polymer electrolyte here is exemplified by gelled polymer electrolytes, and intrinsic polymer electrolytes. The gelled polymer electrolyte here refers to an electrolyte in which a polymer is swollen by a non-aqueous electrolysis solution thereby holding the non-aqueous electrolysis solution in the polymer, and the intrinsic polymer electrolyte here refers to an electrolyte in which a lithium salt is dissolved in a polymer.

For such polymers, for instance, use may be made of polyacrylonitrile, polyethylene glycol, polyvinylidene fluoride (PVdF), polyvinyl pyrrolidone, copolymers of acrylates including polytetraethylene glycol diacrylate, polyethylene oxide diacrylate and ethylene oxide and acrylates having polyfunctional groups, and copolymers of polyethylene oxide, polypropylene oxide or vinylidene fluoride and hexafluoropropylene.

There is also a hybrid type cell system (the so-called hybrid capacitor) thought of as an electrochemical device lying halfway between the lithium secondary battery and the electric double-layer capacitor, which cell system combines an electrostatic capacity that relies on an electric double layer and is capable of extracting large currents with a redox capacity that relies on an electrochemical oxidation-reduction reaction and is capable of ensuring high energy density. This is also the electrochemical device to be covered by the present invention. The hybrid capacitor here is preferably exemplified by the following embodiments.

(1) A hybrid capacitor comprising an electric double-layer capacitor-as one electrode and a lithium ion secondary battery as another electrode wherein, for instance, its positive electrode comprises activated charcoal as a main component and its negative electrode comprises graphite as a main component; and

(2) A hybrid capacitor comprising a combined electric double-layer capacitor and lithium ion secondary battery composite as one electrode and a combined electric double-layer capacitor and lithium ion secondary battery composite as another electrode wherein, for instance, each electrode comprises activated charcoal plus active substance as a main component.

### Explanation of the Inventive Fabrication Process for an Electrodes for Electrochemical Devices

The inventive fabrication process for electrodes for electrochemical devices (the preferable one is the electrode for the above electric double-layer capacitor 20) is now explained.

The inventive fabrication process for electrodes for electrochemical devices, for instance, involves (1) a coating material provision step of providing an electrode-formation coating material, (2) a coating step of coating the coating material on a support carrier to form a coating film, (3) a first drying step of drying the coating film, (4) a rolling step of rolling the coating film, (5) a solvent extraction treatment step for removal of a binder solvent remaining in the coating film, and (6) a second drying step.

The fabrication process of the present invention is now explained for each step.

(1) Coating Material Provision Step of Providing the Electrode-Formation Coating Material

The electrode-formation coating material comprising the active substance, conductive aid, binder and binder solvent is provided. One specific example is given just below.

The binder dissolved in the binder solvent, the active substance and the conductive aid are kneaded together under given conditions in a kneading machine. Thereafter, a given amount of the mixture is charged in a container, in which it is added with the binder solvent in such a way as to have a viscosity well fit for coating. Then, the product is dispersed in a dispersing machine to prepare the desired electrode-formation coating material. For mixing and dispersing operation, mixing/dispersing machines such as hyper mixers, dissolvers, Henschel mixers, planetary mixers, media type mills, and homo mixers may be used alone or in combination of two or more.

It is here noted that the electrode-formation coating material are composed of, per 100 parts by mass of solid matter (active substance plus conductive aid plus binder), about 2 to 25 parts by weight of the binder, and about 2 to 15 parts by weight. And then, the so-called solid matter ratio (solid matter/solid matter plus solvent) is about 24 to 45%.

In the present invention, it is also noted that the larger the specific surface area (e.g., 1,000 to 3,000 m³/g) of the active substance used, the more striking the effect of the present invention becomes.

(2) Coating Step of Coating the Coating Material on the Support Carrier to Form the Coating Film

A support carrier that functions as a collector and is of electric conductivity is provided. Then, the electrode-formation coating material prepared in step (1) is coated on the support carrier as by a doctor blade technique. Other coating techniques such as metal mask printing, electrostatic coating, dip coating, spray coating, roll coating, and screen printing may be used, too. A coating thickness at the time of coating may be of the order of 20 to 400 μm.

(3) First Drying Step of Drying the Coating Film Preferably, the first coating film-drying step is carried out to control the amount of the binder solvent contained in the coating film formed in coating step (2) to within the range of 10 to 35 wt %, and desirously 15 to 20 wt %. At less than 10 wt %, the electrostatic capacity will often drop under the action of the next rolling step. At greater than 35 wt %, the coating film will have a tackiness way too high for convenient handling, often bringing on poor productivity and poor product quality on transfer.

The drying conditions here, for instance, are such that the above amount of the solvent remaining in the coating film is obtainable at a drying temperature of 60 to 100° C. for a drying time of 2 minute to 20 minutes.

(4) Rolling Step of Rolling the Coating Film

Preferably, the rolling step is carried out such that the coating film subjected to the given drying in the above first coating film-drying step is rolled as by a heated rolling roll. Alternatively, a plate press or calender roll or the like may be used. This rolling step ensures an improvement in the density of the coating film. The coating film has a density of the order of 0.55 to 0.75 g/cm³, and preferably 0.60 to 0.70 g/cm³.

In the rolling step, a pressure of the order of 50 kgf/cm to 600 kgf/cm is applied. The rolling step is preferably implemented under pressure in a heated state. In the heated state, the pressurizing roll is desirously heated to about 140° C. to 200° C.

By this rolling operation, the coating film thickness is reduced down to, for instance, about 75 to 90%.

(5) Solvent Extraction Step for Removal of the Binder Solvent Remaining in the Coating Film

After the rolling operation step, the coating film is extracted with a solvent to remove off the binder solvent remaining in the coating film.

The extraction solvent used in this solvent extraction step is compatible with the binder solvent, and has a boiling point lower than that of the binder solvent. The “low-boiling solvent” here is understood to mean a solvent having a boiling point of the order of 50° C. to 100° C.

For instance, when N-methyl-2-pyrrolidinone (NMP) is used as the binder solvent, organic solvent such as acetone, methylene chloride, and alcohol is preferably used as the extraction solvent. For instance, when the binder solvent is changed in association with the change of the binder used, a solvent that is compatible with the binder solvent and has a boiling point lower than that of the binder solvent may be optionally chosen as the low-boiling solvent. The solvent extraction operation successfully gets rid of the high-boiling binder solvent adsorbed into the activated charcoal pores (micropores) thereby removing off it. The low-boiling solvent that remains in place of the binder solvent, because of having a low boiling point, can be easily dried off. In addition, the low-boiling solvent that takes over the binder solvent is treated in a variety of solvent cleaning/circulating systems, and so fits in with mass production with high productivity.

In the present invention, the solvent extraction operation for removal of the binder solvent residues must be implemented after, not before, the rolling operation for increasing the density of the coating film, whereby cell capacity can grow large. Although there has been no technically clear understanding of what actually goes on, this would appear to be because some binder solvent residues present in the rolling operation step make it less likely to clog up the entries of the pores (micropores) in activated charcoal upon rolling operation.

Referring to one specific example of the solvent extraction operation, while electrodes are dipped in the extraction solvent in a reservoir, extraction is carried out under stirring for a given time, after which the electrodes are lifted up and dried for a given time. Preferably for the solvent extraction, such a series of operations are done a few sets (a few cycles).

(6) Second Drying Step

After the above solvent extraction operation, the second drying step is carried out to dry the coating film. By the second drying operation that is ordinarily a vacuum drying operation, the water, extraction solvent, etc. remaining in the coating film are removed off. The drying temperature may be of the order of 120° C. to 200° C., and the drying time may be of the order of 1 to 24 hours.

After the second drying step, the amount of the binder solvent remaining in the electrode is reduced down to 1 wt % or less.

The sheet blank formed through such process steps, for instance, is punched out in a given shape. In this way, the inventive electrodes for electrochemical devices are fabricated.

Next, if the electrodes for electrochemical devices fabricated by such an inventive fabrication process, separators, electrolytes, housings, etc. are assembled together such that they function as an electrochemical device, it is then possible to fabricate an electrochemical device. The thus assembled electrochemical device, for instance, has the form of such an electric double-layer capacitor and lithium secondary battery as depicted in FIGS. 1 and 2.

The present invention is now explained more specifically with reference to some specific examples.

### EXAMPLE 1

### Step of Providing (Preparing) the Electrode-Formation Coating Material

A 5 wt % polyvinylidene fluoride (PVDF) solution with N-methy-2-pyrrolidinone (NMP) used as a solvent (Kureha Chemical Industries Co., Ltd.), carbon black (DAB50 made by Denki Chemical Industries Co., Ltd.) and activated charcoal (RP-20 made by Kurare Chemical Industries Co., Ltd.) were kneaded together at 60 rpm for 1 hour in a kneading machine (PLASTI-CORDER made by Brabender Co., Ltd.).

A given amount of the mixture was charged in a resin container, in which it was added with the solvent (NMP) in such a way as to have a viscosity well fit for coating, and the mixture was dispersed in a dispersing machine (Hybrid Mixer made by Keyence Co., Ltd.).

The thus provided electrode-formation coating material was used to prepare an electrode by the following steps.

Preparation of the Electrode

An etching aluminum foil (40C054 made by Nippon Tikudenki Industries Co., Ltd.) was provided as a collector, and the electrode-formation coating material prepared as mentioned above was coated on that foil by a doctor blade technique.

Thereafter, the coating material was dried at 70° C. for 10 minutes to reduce the amount of the solvent residues in the coating film down to 30 wt %. Thus, the first drying step was complete. The then coating film thickness was about 130 μm.

Then, the electrode was rolled with a heated rolling roll at 160t and a pressure of 300 kgf/cm. By this rolling operation, the coating film thickness was reduced down to about 85%.

Then, for removal of the N-methyl-2-pyrrolidinone (NMP) solvent remaining in the electrode, the extraction operation was carried out in the following manner (the solvent extraction step).

In acetone of 1 liter, twenty five (25) electrodes were housed in an exclusive case while they did not overlap, and extraction was carried out under stirring for a given time. After the completion of the extraction operation, the 25 electrodes were taken out of the exclusive case for drying for a given time. Such a succession of extraction operations were repeated three sets (three cycles) to complete the solvent extraction operation.

Afterward, the electrodes were vacuum dried at 145° C. for 15 hours (the second drying step).

The thus prepared electrode was used to fabricate an electric double-layer capacitor in the following manner.

Fabrication of the Electric Double-Layer Capacitor

The above electrode was punched out into a size of about 32 mm×50 mm. Two such electrodes were stacked together with a separator (of 30 μm in thickness, Model TF4030 made by Nippon Kodoshi Industries Co., Ltd.) interposed between them. A total of five electrodes, i.e., two positive and three negative, were laminated together, and an aluminum foil (of 4 mm in width, 40 mm in length and 0.1 mm thickness) for an external leading tab was ultrasonically welded to a collector portion of each electrode.

The thus formed unitary assembly was inserted into a battery housing, an electrolysis solution was then poured in the housing, and an opening of the housing was finally vacuum heat sealed into an electric double-layer capacitor. Note here that the housing used was composed of a laminated aluminum/polymer material specifically comprising polyethylene terephthalate PET(12)/Al(40) /PP(50), wherein PET, Al and PP are indicative of polyethylene terephthalate, aluminum and polypropylene, respectively, and the bracketed figure is indicative of thickness in μm.

For the above electrolysis solution, a suitable amount of 1.2 M propylene carbonate with triethylmethyl-ammonium borofluoride (TEMA.FB₄) dissolved in it was used.

The thus fabricated electric double-layer capacitor sample was measured for (1) a cell capacity and (2) an initial impedance value and an impedance value after a 120-hour conduction of currents at 2.5V in the following manners.

(1) Cell Capacity

The electric double-layer capacitor was charged and discharged between 0.5 V and 2.5 V. Note here that because the voltage was 0 V just after fabrication, only the first charge was started from 0 V.

At a current value of 30 mA, the 1^{st} up to 10^{th} cycles of charge and discharge were carried out, after which, at a current value of 150 mA, the 11^{th} up to 15^{th} cycles of charge and discharge were performed for measurement of cell capacity. With the number of samples of N=5, the average value of the cell capacities of such samples was determined.

(2) Initial Impedance Value and Impedance Value after 120-Hour Conduction of 2.5 V

The initial impedance value after fabrication of the electric double-layer capacitor was measured with an impedance measuring device of Solartron Co., Ltd., England. Then, after a 120-hour conduction of currents at 2.5 V, the impedance value of the electric double-layer capacitor was measured.

The results of measurement for check points (1) and (2) are reported in Table 1.

Note that the amount of NMP remaining in the electrode (the coating film), as set out in Table 1, was measured by what is called the purge-and-trap (P&T) GC/MS method.

### EXAMPLE 2

In Example 1, electrode fabrication was carried out such that the amount of the solvent remaining in the coating film after the first drying step was set at 15 wt %. Otherwise as in Example 1, electric double-layer capacitor samples of Example 2 were prepared.

### COMPARATIVE EXAMPLE 1

In Example 1, electrode fabrication was carried out such that the amount of the solvent remaining in the coating film after the first drying step was set at 5 wt %. Otherwise as in Example 1, electric double-layer capacitor samples of Comparative Example 1 were prepared.

### COMPARATIVE EXAMPLE 2

In Example 1, electrode fabrication was carried out such that the amount of the solvent remaining in the coating film after the first drying step was set at 40 wt %. Otherwise as in Example 1, electric double-layer capacitor samples of Comparative Example 2 were tentatively prepared. However, the given number of samples could not be obtained all in a completed form for reasons that the tackiness of the coating film after the first drying step was way too large for handling, there was transfer of the coating film, etc.

### EXAMPLE 3

In Example 1, the acetone used in the solvent extraction step was changed to ethanol. Otherwise as in Example 1, electric double-layer capacitor samples of Example 3 were prepared.

### EXAMPLE 4

In Example 2, the acetone used in the solvent extraction step was changed to ethanol. Otherwise as in Example 2, electric double-layer capacitor samples of Example 4 were prepared.

### COMPARATIVE EXAMPLE 3

In Example 1, electrode fabrication was carried out such that the amount of the solvent remaining in the coating film after the first drying step was set at 5 wt %. Further in Example 1, the acetone used in the solvent extraction step was changed to ethanol. Otherwise as in Example 1, electric double-layer capacitor samples of Comparative Example 3 were prepared.

### EXAMPLE 5

In Example 1, the acetone used in the solvent extraction step was changed to methylene chloride. Otherwise as in Example 1, electric double-layer capacitor samples of Example 4 were prepared.

### EXAMPLE 6

In Example 2, the acetone used in the solvent extraction step was changed to methylene chloride. Otherwise as in Example 6, electric double-layer capacitor samples of Example 6 were prepared.

### COMPARATIVE EXAMPLE 4

In Example 1, electrode fabrication was carried out such that the amount of the solvent remaining in the coating film after the first drying step was set at 5 wt %. Further in Example 1, the acetone used in the solvent extraction step was changed to methylene chloride. Otherwise as in Example 1, electric double-layer capacitor samples of Comparative Example 4 were prepared.

### COMPARATIVE EXAMPLE 5

Example 1 was repeated with the exception that the order of the rolling step and the solvent extraction step was reversed. Otherwise as in Example 1, electric double-layer capacitor samples of Comparative Example 5 were prepared.

That is, after the completion of the first drying step, for removal of the N-methyl-2-pyrrolidinone (NMP) solvent remaining in the electrode, the extraction operation was carried out in the following manner (the solvent extraction step).

In acetone of 1 liter, twenty five (25) electrodes were housed in an exclusive case while they did not overlap, and extraction was carried out under stirring for a given time. After the completion of the extraction operation, the 25 electrodes were taken out of the exclusive case for drying for a given time. Such a succession of extraction operations were repeated three sets (three cycles) to complete the solvent extraction operation. By this solvent extraction operation, the amount of NMP in the electrode prior to entering the next rolling step was reduced down to 0.1 wt %, as set out in Table 1 given later.

After the completion of this solvent extraction step, the electrode was rolled on a heated rolling roll. The rolling operation was carried out at a temperature of 160° C. and a pressure of 300 kg/cm. By this rolling operation, the coating film thickness was reduced down to about 85%.

Afterward, the electrodes subjected to the rolling operation were vacuum dried at 145° C. for 15 hours (the second drying step).

The thus prepared electrode was used to fabricate an electric double-layer capacitor.

### COMPARATIVE EXAMPLE 6

In Comparative Example 5, the acetone used in the solvent extraction step was changed to methylene chloride. Otherwise as in Comparative Example 5, electric double-layer capacitor samples of Comparative Example 6 were prepared. Note here that by the solvent extraction operation, the amount of NMP in the electrode prior to entering the next rolling step was reduced down to 0.5 wt %, as set out in Table 1 given later.

### COMPARATIVE EXAMPLE 7

In Example 1, the solvent extraction step was not conducted. Otherwise as in Example 1, electric double-layer capacitor samples of Comparative Example 7 were prepared.

Each of these electric double-layer capacitor samples was estimated in the same manner as in Example 1. The results are set out in Table 1.

TABLE 1

| | | Amount of NMP in | Amount of NMP in |
|---|---|---|---|
| | Extraction | the electrode | the electrode |
| Sample No. | Solvent | before rolling | after completion |
| Ex. 1 | (A) | 30 wt % | 0.1 wt % |
| Ex. 2 | (A) | 15 wt % | 0.1 wt % |
| Comp. Ex. 1 | (A) | 5 wt % | 0.1 wt % |
| Comp. Ex. 2 | (A) | 40 wt % | — |
| Ex. 3 | (E) | 30 wt % | 0.1 wt % |
| Ex. 4 | (E) | 15 wt % | 0.1 wt % |
| Comp. Ex. 3 | (E) | 5 wt % | 0.1 wt % |
| Ex. 5 | (MC) | 30 wt % | 0.1 wt % |
| Ex. 6 | (MC) | 15 wt % | 0.1 wt % |
| Comp. Ex. 4 | (MC) | 5 wt % | 0.1 wt % |
| Comp. Ex. 5 | (*) | 0.1 wt % | 0.1 wt % |
| Comp. Ex. 6 | (**) | 0.5 wt % | 0.3 wt % |
| Comp. Ex. 7 | (A) | 30 wt % | 1.7 wt % |

Impedance (mΩ)

| | | | After conduction of |
|---|---|---|---|
| Sample No. | Cell Capacity (F) | Initial | 2.5 V-120 hr |
| Ex. 1 | 27.2 | 28 | 43 |
| Ex. 2 | 26.9 | 28 | 45 |
| Comp. Ex. 1 | 26.2 | 30 | 55 |
| Comp. Ex. 2 | — | — | — |
| Ex. 3 | 26.9 | 28 | 45 |
| Ex. 4 | 26.8 | 28 | 45 |
| Comp. Ex. 3 | 25.8 | 30 | 54 |
| Ex. 5 | 27.1 | 28 | 44 |
| Ex. 6 | 26.9 | 28 | 46 |
| Comp. Ex. 4 | 25.9 | 30 | 55 |
| Comp. Ex. 5 | 25.5 | 32 | 65 |
| Comp. Ex. 6 | 25.5 | 31 | 66 |
| Comp. Ex. 7 | 25.6 | 41 | 60 |

NMP: N-methyl-2-pyrrolidinone
(A): acetone
(E): ethanol
(MC): methylene chloride
(*): treated with acetone before rolling
(**): treated with methylene chloride before rolling

The results of experimentation set out in Table 1 are proof of the advantages of the present invention.

In the inventive fabrication process for electrodes for electrochemical devices, when the coating film is rolled so as to increase its density, the given binder solvent is intentionally allowed to remain in an amount good enough to keep micropores on the surface of the active substance uncrushed, and after said rolling operation is carried out, the solvent extraction operation is conducted to remove the binder solvent remaining in the micropores in the coating film. Thus, an electrochemical device using an electrode according to the inventive fabrication process is much improved in electrostatic capacity as well as in durability and reliability as well.

What we claim is:

1. A process for fabricating an electrode for electrochemical devices, said electrode comprising an active substance and a binder on a support carrier, characterized by comprising:
a coating material providing step of providing an electrode-formation coating material comprising said active substance, said binder and a binder solvent,
a coating step of coating said coating material on said support carrier to form a coating film for said electrode,
a first coating film drying step for regulating an amount of the binder solvent contained in a coating film formed in said coating step to within a range of 10 to 35 wt %,
a rolling step of rolling the coating film in which the amount of the binder solvent is regulated by said first coating film drying step,
a solvent extraction step for removing the binder solvent remaining in the coating film after said rolling step, and
a second drying step of drying the coating film after said solvent extraction step.

2. The process for fabricating an electrode for electrochemical devices according to claim 1, wherein an extracting solvent used in said solvent extraction step is compatible with said binder solvent, and has a boiling point lower than that of said binder solvent.

3. The process for fabricating an electrode for electrochemical devices according to claim 1, wherein an amount of the binder solvent remaining in an electrode after said second drying step is 1 wt % or less.

4. The process for fabricating an electrode for electrochemical devices according to claim 1, wherein the coating film after said rolling step has a density of 0.55 to 0.75 g/cm³.

5. The process for fabricating an electrode for electrochemical devices according to claim 1, wherein said second drying step is carried out in a vacuum.

6. The process for fabricating an electrode for electrochemical devices according to claim 1, wherein said electrode for electrochemical devices is an electrode for electric double-layer capacitors, an electrode for lithium ion secondary batteries, or an electrode for hybrid capacitors.

7. An electrochemical device fabrication process, wherein:
an electrode for electrochemical devices, comprising an active substance and a binder on a support carrier, is fabricated by a process for fabricating an electrode for electrochemical devices comprising:
a coating material providing step of providing an electrode-formation coating material comprising said active substance, said binder and a binder solvent,
a coating step of coating said coating material on said support carrier to form a coating film for said electrode,
a first coating film drying step for regulating an amount of the binder solvent contained in a coating film formed in said coating step to within a range of 10 to 35 wt %,
a rolling step of rolling the coating film in which the amount of the binder solvent is regulated by said first coating film drying step,
a solvent extraction step for removing the binder solvent remaining in the coating film after said rolling step, and
a second drying step of drying the coating film after said solvent extraction step, and thereafter,
the thus fabricated electrode for electrochemical devices, a separator, an electrolyte and a housing are assembled together into an electrochemical device.
